(19) United States
(12) Patent Application Publication
(10) Pub. No.: US 2018/0160721 A1
(43) Pub. Date: Jun. 14, 2018

(54) METHOD FOR PROVIDING A PARTICULATE TOBACCO PRODUCT AND DEVICE FOR THE TOBACCO-PROCESSING INDUSTRY

(71) Applicant: HAUNI MASCHINENBAU GMBH, Hamburg (DE)

(72) Inventors: Helmut VOSS, Neumuenster (DE); Corinna ZU PUTLITZ, Kuddewoerde (DE)

(73) Assignee: HAUNI MASCHINENBAU GMBH, Hamburg (DE)

(21) Appl. No.: 15/890,848

(22) Filed: Feb. 7, 2018

Related U.S. Application Data
(63) Continuation of application No. PCT/EP2016/068281, filed on Aug. 1, 2016.

(30) Foreign Application Priority Data
Aug. 12, 2015 (DE) 10 2015 113 292.3

(51) Int. Cl. A24B 3/14; A24B 15/12; A24B 3/12; A24B 5/14; B65G 19/14

(52) U.S. Cl. CPC A24B 3/14; A24B 15/12; B65G 2812/99; A24B 5/14; B65G 19/14; A24B 3/12

(57) ABSTRACT

Method for providing a particulate tobacco product and a device of the tobacco processing industry for performing the method. After harvesting tobacco plant, the method includes shredding the harvested tobacco plant and processing the shreds of the tobacco plant to form flat reconstituted tobacco material. The method also includes conveying the flat reconstituted tobacco material in a processing plane to a punching station. Further, the method includes punching tobacco particles out of the tobacco material in the punching station with a punching tool and providing the punched-out tobacco particles as particulate tobacco product.

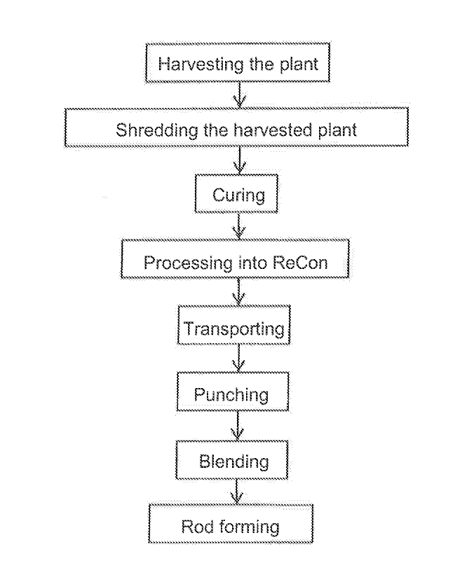

### CROSS-REFERENCE TO RELATED APPLICATIONS

The present application is Continuation of International Application No. PCT/EP2016/068281 filed Aug. 1, 2016 claiming the priority of German Application No. 10 2015 113 292.3 filed Aug. 12, 2015, the disclosures of which are expressly incorporated by reference herein in their entireties.

### BACKGROUND OF THE INVENTION

### 1. Field of the Invention

Embodiments relate to a method for producing a particulate tobacco product in which tobacco plants are harvested in a first step. Moreover, the invention relates to a device of the tobacco-processing industry for carrying out such a method.

### 2. Discussion of Background Information

In harvesting tobacco, individual leaves of the tobacco plant are harvested depending on maturity. The harvest starts with the bottom leaves, as the tobacco plant is typically harvested from bottom to top in several passes. After the harvest, the tobacco leaves must be dried. For this, the individual leaves are threaded onto strings and frequently hung in a shed or hall so that the tobacco dries in the air. The drying process can be supported by fire or hot air. It is also known to let the tobacco leaves dry in the sun.

In addition to harvesting individual tobacco leaves, so-called “whole-plant harvesting” is known in which the tobacco plant is cut above the root and hung up to dry. Such a harvesting method is known for example from WO 2014/032784. In the described method, after drying, the tobacco plant as a whole is threshed in order to obtain the leaf material, the lamina. This is supplied for further processing. After the tobacco plant is dried, it is also known to harvest its leaves and supply only them to further processing. For example, the tobacco leaves are threshed, and the obtained lamina is then processed into cut tobacco. The stem of the tobacco plant that remains in both cases is frequently used as burning material.

### SUMMARY

On the basis of the known art, embodiments of the invention are directed to a method for producing a particulate tobacco product, as well as a device of the tobacco-processing industry, whereby production is simplified and more flexible.

Embodiments are achieved with a method for providing a particulate tobacco product in which tobacco plants are harvested in a first step, and which is further developed by the following additional steps subsequent to the first step:
a) shredding the harvested tobacco plant,
b) processing the shreds of the tobacco plant to form flat reconstituted tobacco material,
c) conveying the flat reconstituted tobacco material in a processing plane to a punching station,
d) punching tobacco particles out of the tobacco material in the punching station by using a punching tool, and
e) providing the punched-out tobacco particles as particulate tobacco product.

Advantageously, a method is provided that can be carried out over the entire process with a high degree of automation. The necessary effort during the tobacco harvest is significantly lower. Instead of harvesting individual leaves of the tobacco plant in several harvesting passes, the entire tobacco plant is harvested and in particular processed further directly afterward. The harvesting process is carried out in particular mechanically or with mechanical support. The tobacco plant is severed, for example, cut, above the root. The bottom leaves remain on the field. According to another embodiment, the tobacco plant is severed at a predetermined height. For example, the tobacco plants are severed above the sand lugs so that only the upper middle leaves, lower middle leaves and top leaves are harvested. Of course, it is also possible to sever the plant farther up, for example to achieve a desired nicotine content in the harvested plant. Accordingly, only the top leaves and upper middle leaves would be harvested, for example. It is also provided for the harvest to occur in several passes. For example, first a top part of the tobacco plant is harvested and then, in another possibly delayed harvest pass, the bottom part of the tobacco plant is also harvested. Like the first harvest pass, the other passes are in particular by machine or machine-supported. Preferably, the tobacco plant is, however, harvested completely in a single harvest pass.

According to aspects of the invention, the method is however not only significantly simplified with regard to the harvest, but also with regard to the further processing of the tobacco plant. In contrast to the traditional whole-plant harvest, the entire plant is severed, hung up upside down to dry and then, after drying the plant, the leaves are individually harvested, the entire tobacco plant is processed further according to aspects of the invention. It is completely shredded. This concerns not just to the tobacco leaves but also the stem of the tobacco plant.

The shreds of the tobacco plant obtained thereby are processed further into reconstituted tobacco material. This method step is also advantageously carried out with a high degree of automation. In particular, the shreds are processed into a sheet of tobacco.

The processing of the shreds of the tobacco plant into flat, reconstituted tobacco material, in particular into a tobacco sheet, is carried out according to a method that is known per se for producing reconstituted tobacco material. An overview of the known methods is provided for example by the book “Tobacco Encyclopedia”, pub. Ernst Voges, 1984, in the section “Sheet Tobacco” in the article with the heading “Major Processes in the Manufacture of Sheet Tobacco”, page 389 et seq.

The flat, reconstituted tobacco material is then supplied to a punching station. In the punching station, tobacco particles are punched out of the flat tobacco material consisting of reconstituted tobacco material.

A corresponding method and apparatus with which the particulate tobacco product can be produced in a punching method can be found in the non-prepublished German patent application with the official application number 10 2015 107 971.2 published by the applicant, formerly known as Hauni Maschinenbau AG, Hamburg. The contents of this application is incorporated by reference herein in its entirety.

Advantageously, particulate tobacco product is produced in the punching process which is distinguished by high homogeneity. Reconstituted tobacco material is very homogeneous in comparison to leaf tobacco. Consequently, the punched out tobacco particles also constitute only a homogeneous fraction. The particulate tobacco product is ideally suited for further industrial processing.

For example, the tobacco product can be processed further in a manner comparable with bulk product. Different than with conventional, cut leaf tobacco, it is no longer necessary to directly separate the individual fraction in a distributor apparatus, as is part of a rod-forming machine such as a cigarette machine, or arranged upstream therefrom. Sifting of the ribs components in the distributor unit of the cigarette machine can also be completely discarded. It is accordingly no longer necessary to provide a zig zag separator at that location. Treatment and homogenization of the tobacco mixture in a post-distributor which is traditionally provided downstream can be advantageously entirely discarded. This simplification of the machine has a positive effect on the overall process costs.

Moreover, the opportunity is created of easily adding, or respectively mixing in additives in the form of bulk product or in liquid form as well to the particulate tobacco product.

According to another embodiment, it is provided to punch out tobacco particles of different size and/or shape and then mix them with each other. This is easily accomplished by using or employing a corresponding punching tool. It is accordingly possible to produce different shapes and/or sizes of tobacco particles in a single punching process. The ratios of the different tobacco particles to each other are preferably intentionally selected with regard to an optimum fiber composite, for example with regard to filling ability, hardness, loose ends or pulling resistance of the cigarettes produced therefrom. The production process is very flexible since a corresponding distribution of the punched-out tobacco particles can be realized by selecting a corresponding punching tool. A change of the composition is easily realized by changing the punching tool, and therefore only requires very minimal conversion measures with regard to the machine. Such a high flexibility is unachievable with conventional processes.

According to another embodiment, the process for providing a particulate tobacco product is designed to be more flexible in that it is further developed such that the punched-out tobacco particles (see the aforementioned step d)) are mixed with additional tobacco particles in a predetermined ratio. This mixture is provided as particulate tobacco product.

The other tobacco particles are in particular also punched out tobacco particles. These are moreover in particular punched out of tobacco leaves. It is however also possible to add cut tobacco as the additional tobacco particles to the punched-out, reconstituted tobacco particles. Moreover, it is provided in particular to mix tobacco particles of different types of tobacco with each other in a desired and predetermined ratio in the context of brand-specific blending. Advantageously, the punched-out tobacco particles are mixed with the other tobacco particles in a pouring process. Advantageously, this process is technically particularly simple. It is moreover advantageous when the additional tobacco particles are also punched-out tobacco particles and accordingly form a very homogeneous fraction in terms of their size and/or shape. A particularly good mixture is achieved with the punched-out reconstituted tobacco particles so that both subsequent sifting and further mixing can be discarded.

According to another embodiment, mixing occurs directly in or directly before a rod-forming section, for example a rod-forming machine, in particular a cigarette machine. It is moreover a cigarette machine as is known under the name of “PROTOS” by Hauni Maschinenbau AG, Hamburg.

According to another embodiment, the method is advantageously further developed in that the particulate tobacco product is conveyed in a continuous conveying process in a non-pneumatic tobacco conveying apparatus to a rod-forming section and provided thereto. In this context, it is in particular provided that the particulate tobacco product is conveyed with a tube chain conveyor as a non-pneumatic tobacco conveying apparatus.

A corresponding tube chain conveyor is described in the non-prepublished German application with the official application number 10 2014 210 719 by the applicant, formerly known as Hauni Maschinenbau AG, Hamburg. In the application, the tube chain conveyor is termed a “machine arrangement of the tobacco processing industry”. The content of the above-noted application is incorporated in the present description by means of reference.

Advantageously, transportation is gentle since it occurs without using compressed air. There is no degradation and loss of flavor additives (deflavoring). Moreover, non-pneumatic conveyance saves energy since compressed air is an expensive operating resource. It is also advantageous that the pneumatic supply of the cigarette machine is discarded. The tobacco mixture only falls into the machine under gravity. With the non-pneumatic conveying apparatus, a 100% duty cycle and efficiency are also achieved.

Rod formation is gentler with reduced degradation of the tobacco material. A simpler pouring process is established. In other words, a separator such as a zigzag separator is discarded along with a post-distribution unit arranged downstream. Homogenization of the particulate tobacco product is nonessential given their already very homogeneous structure.

A distribution apparatus is known, for example, from the German patent application with the official application number 10 2012 109 903 by Hauni Maschinenbau AG, Hamburg, or the European application with the official application number 2 721 936 by Hauni Maschinenbau AG, Hamburg. The distribution apparatus disclosed therein comprises a separator through which passes the tobacco material, generally designated “fiber material” or “tobacco fiber material” therein. A post-distribution unit is arranged downstream from the separator that serves to homogenize the fiber material before it is supplied to rod formation.

In the method according to aspects of the invention, the necessity of sifting the provided tobacco product or the necessity of post-distribution in the known art is advantageously discarded. Correspondingly, these components can be discarded in the aforementioned distribution apparatus. Due to its homogeneous properties both in terms of size and in terms of shape, the particulate tobacco product can be easily provided in a pouring process and mixed. This also concerns the supplying of additives that likewise can be added to the particulate tobacco product in a simple pouring process.

The method is further developed in particular in that the shreds of the tobacco plant are matured before they are processed into reconstituted tobacco material.

The aging of the tobacco plant, also termed “curing,” is a process that is generally known per se in tobacco processing. It is described, for example, in the book, “Tobacco Encyclopedia”, pub. Ernst Voges, 1984, in the section “Curing” starting on page 398. The statements made therein relate to the curing of tobacco leaves. According to aspects of the invention, they likewise apply to the treatment of the shreds of the harvested tobacco plant that is subjected to the curing process instead of the tobacco leaves.

Finally, another embodiment provides that the method is further developed in that the flat, reconstituted tobacco material is wound on bobbins, then transported and unwound before being conveyed to the punching station.

Since an intermediate step, i.e., the winding of the tobacco material, is inserted between the production of the reconstituted tobacco material and the conveyance to the punching station, the first method steps a) and b) can be carried out in the tobacco's country of origin, and the subsequent method steps c) to e) can be carried out in the country in which subsequent cigarette production occurs. Accordingly, the labor-intensive steps are advantageously performed in the tobacco's country of origin which frequently has a lower wage level. Moreover, transporting the reconstituted tobacco material instead of the tobacco is easy and efficient. In comparison to the tobacco plants, or respectively their shreds, a significantly lower volume must in fact be transported.

In embodiments, a device of the tobacco-processing industry for performing the method according to one or more of the aforementioned aspects is provided.

Embodiments of the invention are directed to a method for providing a particulate tobacco product from a harvested tobacco plant. The method includes shredding the harvested tobacco plant and processing the shreds of the tobacco plant to form flat reconstituted tobacco material. The method also includes conveying the flat reconstituted tobacco material in a processing plane to a punching station and further includes punching tobacco particles out of the tobacco material in the punching station with a punching tool and providing the punched-out tobacco particles as particulate tobacco product.

In embodiments, the method can also include mixing the punched out tobacco particles with other tobacco particles in a predetermined ratio and providing the mixture as the particulate tobacco product. The punched out tobacco particles can be mixed with the other tobacco particles in a pouring process.

According to embodiments, the method can include conveying the particulate tobacco product in a continuous conveying process in a non-pneumatic tobacco conveying apparatus to a rod-forming section. The non-pneumatic tobacco conveying apparatus can include a tube chain conveyor.

In accordance with other embodiments, the method can include curing the shreds of the tobacco plant before the shreds are processed into the flat reconstituted tobacco material.

In other embodiments, before tobacco particles are punched out of the tobacco material in the punching station, the method can include winding the flat, reconstituted tobacco material on bobbins, transporting the wound flat, reconstituted tobacco material to the punching station and unwinding the wound flat, reconstituted tobacco material from the bobbins.

According to still other embodiments, the harvested tobacco plant may be severed above the root. In this regard, at least one of: the tobacco plants can be severed above the sand lugs so that only the upper middle leaves, lower middle leaves and top leaves are harvested, the tobacco plants can be severed so that only the top leaves and upper middle leaves are be harvested and the tobacco plants can be completely harvested in a single harvest pass.

In embodiments the shredding of the harvested tobacco plant may include shredding the entire harvested tobacco plant.

In still other embodiments, the shredding of the harvested tobacco plant may include shredding the tobacco leaves and stem of a severed tobacco plant.

According to still other embodiments, the method can also include forwarding the particulate tobacco product to a rod-forming machine, whereby rods can be formed from the particulate tobacco product without separating an individual fraction of cut leaf tobacco in a distributor.

In accordance with still yet other embodiments of the present invention, the method may include forwarding the particulate tobacco product to a rod-forming machine, whereby rods can be formed from the particulate tobacco product without sifting of rib components.

Embodiments are directed to a device of the tobacco-processing industry for performing any of the above-noted embodiments of the method.

The same or similar advantages relate to the device of the tobacco processing industry as have already been mentioned with regard to the method for providing a particulate tobacco product, so a further description will be dispensed with.

Further features of the invention will become apparent from the description of embodiments according to the invention together with the claims and the included drawing. Embodiments according to the invention can fulfill individual features or a combination of several features.

### BRIEF DESCRIPTION OF THE DRAWINGS

The invention is described below, without restricting the general idea of the invention, based on exemplary embodiments in reference to the drawing, whereby reference is expressly made to the drawing with regard to the disclosure of all details according to the invention that are not explained in greater detail in the text. The following is shown:

The FIGURE is a simplified, schematic flowchart of a method for providing a particulate tobacco product as can be carried out by a device of the tobacco-processing industry.

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The FIGURE schematically illustrates a simplified method 100 that starts with the harvesting of the tobacco plant 101. Preferably, a whole-plant harvesting is carried out in which the tobacco plant is severed above the root. Then the harvested tobacco plant is shredded 102. The shreds of the tobacco plants obtained in this manner are supplied to a curing process 103. During the curing, a fermentation of the contents of the shreds of the harvested tobacco plant occurs. The curing process occurs, e.g., in a silo.

The aging of the tobacco plant, also termed “curing,” is known per se in the art and is described, e.g., in the book, “Tobacco Encyclopedia”, pub. Ernst Voges, 1984, in the section “Curing”, starting on page 398. The statements made with regard to the curing of tobacco leaves apply equally or similarly to the curing of the shreds of the harvested tobacco plant.

The cured shreds of the tobacco plant are then processed into flat, reconstituted tobacco material 104.

Before being processed into reconstituted tobacco material, the cured shreds of harvested tobacco plant can be transported for processing. For this purpose, the shreds are in particular compacted in order to minimize the volume of material to be transported. However, it is also to be understood that the production of the flat reconstituted tobacco material occurs in proximity to the production facility for the tobacco shreds. In this way, the produced flat, reconstituted tobacco material can be subsequently transportated from a processing site in feature 104 to a location at which production of the tobacco products ultimately produced from the tobacco material occurs, e.g., in another country. For example, as part of feature 104 of the method, a tobacco sheet is produced as the flat, reconstituted tobacco material and is in particular wound on bobbins for transportation. Of course, transportation is optional and may not be needed when the subsequent processing occurs in proximity to the production site of the reconstituted tobacco material.

The processing of tobacco into reconstituted tobacco material is also a process that is known per se in tobacco processing. It is described, e.g., in the book “Tobacco Encyclopedia”, pub. Ernst Voges, 1984, in the section “Sheet Tobacco” in the article with the heading “Major Processes in the Manufacture of Sheet Tobacco”, page 389 et seq. The flat, reconstituted tobacco material processed in feature 104 is provided, for example, as a rolled product or sheet product at the end of the process.

When the reconstituted tobacco material is to be further processed, i.e., into ultimate tobacco products, at a location not proximate the site in which the reconstituted tobacco material was processed, e.g., in another country, method 100 can further include transporting the reconstituted tobacco material 105. Transporting 105 of the reconstituted tobacco material is particularly advantageous since the tobacco material is in compact form, which is in contrast to the harvested tobacco plant, and therefore a substantially smaller transport volume has to be dealt with.

The flat, reconstituted tobacco material, in particular, a tobacco sheet, is then supplied to a punching station 106. For example, the tobacco sheet is wound off a bobbin and supplied in a plane to the punch. An punching apparatus described, e.g., in the non-prepublished German application with the official application number 10 2015 107 971.2 by Hauni Maschinenbau AG, Hamburg can serve in particular as the punching station in 106. The disclosure of German Application No. 10 2015 107 971.2 is expressly incorporated by reference herein in its entirety. In the noted application, a punching station is described in detail as a “device of the tobacco-processing industry for producing the particulate tobacco product.”

It is understood in particular that tobacco particles of different shape and/or size are punched out in the punching process 106. This is accomplished by selecting a corresponding punching tool. The size and/or shape of the tobacco particles are selected in light of the properties of the tobacco product to be produced therefrom for subsequent rod formation. It is moreover provided in particular that the punched-out reconstituted tobacco material is mixed with additional particulate tobacco product. The latter is in particular also produced in the punching process 106. However, it is also be understood that cut tobacco product can be added to the reconstituted punched-out tobacco product. The added tobacco material is, for example, leaf tobacco or reconstituted tobacco material.

Subsequently, mixing or blending 107 is carried out in which a tobacco mixture provided for rod formation is produced. For example, tobacco particles of different types of tobacco or reconstituted tobacco material of different types and/or flavors are mixed with each other. Given the homogeneous properties of the punched-out tobacco particles, the mixing can advantageously occur in a single pouring process.

Moreover, it is provided in particular that the produced tobacco mixture is provided with taste additives, for example to provide a brand-specific tobacco mixture.

After the blending 106 of the tobacco particles, they are provided to a rod-forming section 108. The rod-forming section is for example a cigarette machine as is known, e.g., under the name of “PROTOS” by Hauni Maschinenbau AG, Hamburg.

Traditionally, the rod-forming section is located upstream from a distributor unit. A distributor unit is described, for example, in the German patent application with the official application number 10 2012 109 903 by Hauni Maschinenbau AG, Hamburg, or the European application with the official application number 2 721 936 by Hauni Maschinenbau AG, Hamburg. The distributor apparatus disclosed therein comprises a separator, such as a zig-zag separator, in which for example components of tobacco leaves stalks are sorted out. However, as these components are not contained in a tobacco product provided according to the embodiments of the invention, such a separator can be advantageously discarded. In addition, as the particulate tobacco product is in a very homogeneous fraction, the traditional post-distribution unit provided in a distributor apparatus can therefore also be discarded. This simplifies the construction of the rod-forming unit, or respectively distributor apparatus.

The particulate tobacco product is transported to the rod-forming unit, preferably using a non-pneumatic conveyor such as a tube chain conveyor. This is described in the non-prepublished German application with the official application number 10 2014 210 719 by the applicant, formerly known as Hauni Maschinenbau AG, Hamburg.

The method described in the FIGURE for providing a particulate tobacco product advantageously can be carried out using a high degree of automation. For this reason, it is highly efficient, in particular compared with traditional methods.

All named features, including those taken from the drawing alone, and individual features, which are disclosed in combination with other features, are considered alone and in combination as essential for the invention. Embodiments according to the invention can be fulfilled through individual features or a combination of several features. In the context of the invention, features which are designated with “in particular” or “preferably” are to be understood as optional features.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A method for providing a particulate tobacco product from a harvested tobacco plant, the method comprising:
a) shredding the harvested tobacco plant;
b) processing the shreds of the tobacco plant to form flat reconstituted tobacco material;
c) conveying the flat reconstituted tobacco material in a processing plane to a punching station;
d) punching tobacco particles out of the tobacco material in the punching station with a punching tool; and
e) providing the punched-out tobacco particles as particulate tobacco product.

2. The method according to claim 1, further comprising mixing the punched out tobacco particles with other tobacco particles in a predetermined ratio and providing the mixture as the particulate tobacco product.

3. The method according to claim 2, wherein the punched out tobacco particles are mixed with the other tobacco particles in a pouring process.

4. The method according to claim 1, further comprising conveying the particulate tobacco product in a continuous conveying process in a non-pneumatic tobacco conveying apparatus to a rod-forming section.

5. The method according to claim 4, wherein the non-pneumatic tobacco conveying apparatus comprises a tube chain conveyor.

6. The method according to claim 1, further comprising curing the shreds of the tobacco plant before the shreds are processed into the flat reconstituted tobacco material.

7. The method according to claim 1, wherein, before tobacco particles are punched out of the tobacco material in the punching station, the method further comprises:
winding the flat, reconstituted tobacco material on bobbins;
transporting the wound flat, reconstituted tobacco material to the punching station; and
unwinding the wound flat, reconstituted tobacco material from the bobbins.

8. The method according to claim 1, wherein the harvested tobacco plant is severed above the root.

9. The method according to claim 8, wherein at least one of:
the tobacco plants are severed above the sand lugs so that only the upper middle leaves, lower middle leaves and top leaves are harvested;
the tobacco plants are severed so that only the top leaves and upper middle leaves are be harvested; and
the tobacco plants are completely harvested in a single harvest pass.

10. The method according to claim 1, wherein the shredding of the harvested tobacco plant comprises shredding the entire harvested tobacco plant.

11. The method according to claim 1, wherein the shredding of the harvested tobacco plant comprise shredding the tobacco leaves and stem of a severed tobacco plant.

12. The method according to claim 1, further comprising forwarding the particulate tobacco product to a rod-forming machine, whereby rods are formed from the particulate tobacco product without separating an individual fraction of cut leaf tobacco in a distributor.

13. The method according to claim 1, further comprising forwarding the particulate tobacco product to a rod-forming machine, whereby rods are formed from the particulate tobacco product without sifting of rib components.

14. A device of the tobacco-processing industry for performing the method according to claim 1.
